(19) United States
(12) Patent Application Publication
(10) Pub. No.: US 2025/0303844 A1
(43) Pub. Date: Oct. 2, 2025

(54) POWER TRANSMISSION DEVICE FOR HYBRID VEHICLE

(71) Applicant: Hyundai Transys Inc., Seosan-si (KR)

(72) Inventors: Seung Hyun KIM, Hwaseong-si (KR); Bon Kyung KOO, Hwaseong-si (KR); Hyun Kyu KIM, Hwaseong-si (KR); Yeon Tae LEE, Hwaseong-si (KR)

(21) Appl. No.: 18/937,597

(22) Filed: Nov. 5, 2024

(30) Foreign Application Priority Data
Mar. 26, 2024 (KR) 10-2024-0040828

(51) Int. Cl. B60K 6/36; B60K 6/26; B60K 6/442; F16H 37/08

(52) U.S. Cl. CPC B60K 6/36; B60K 6/26; B60K 6/442; F16H 37/0806; B60Y 2200/92

(57) ABSTRACT

Provided is a power transmission device for a hybrid vehicle including an engine configured to generate power, an input connected with the engine and configured to provide one-speed power, a first motor generator driven when power is applied, a first transmission connected with the first motor generator, positioned parallel to the input, and configured to transmit power to the input, an output engaged with the input, a second motor generator driven when power is applied, a second transmission connected with the second motor generator, positioned parallel to the output, and configured to transmit power to the output, and a differential engaged with the output and configured to provide power to wheels.

### CROSS-REFERENCE TO RELATED APPLICATION

This application claims the benefit of Korean Patent Application No. 10-2024-0040828, filed Mar. 26, 2024, the disclosure of which is incorporated by reference herein in its entirety.

### BACKGROUND

### Field

Exemplary embodiments of the present disclosure relate to a power transmission device for a hybrid vehicle, and more particularly, to a power transmission device for a hybrid vehicle capable of removing a clutch connecting an engine power, securing space for a first motor and a second motor, and reducing an overall length.

### Discussion of the Background

In general, a power transmission device for a hybrid vehicle has a layout in which a motor, an engine, and an integrated starter-generator (ISG) are arranged in a line.

In a hybrid vehicle utilizing the engine and the motor, the motor is used to facilitate the initial start of the vehicle. Once the vehicle reaches a certain speed, the generator, or ISG, starts the engine so that both the output of the engine and the output of the motor are used.

The motor used in the power transmission device for a hybrid vehicle may be driven to enable electric driving of the vehicle when the engine is not initially running.

Recently, the number of motors is not limited to one. Instead, two or more motors are positioned in multiples. For example, when two motors are positioned in the power transmission device for a hybrid vehicle, a first motor may be driven to start the engine, and a second motor may be driven for electric driving of the vehicle.

However, in the related art, the motor needs to be large to deliver the required torque for the vehicle, making it difficult to design the layout. When a friction clutch is provided on a power shaft connecting the engine and the transmission, there is an issue of increased product length and self-load due to the large size of the friction clutch. In addition, when a dog clutch is provided on the power shaft connecting the engine and the transmission, the motor needs to be concentrically positioned with the engine, which is a limitation in terms of an overall length. Therefore, it is necessary to address this issue.

The background technology of the present disclosure is disclosed in Korean Patent Application Publication No. 2009-0020791 (published on Feb. 27, 2009 and entitled “POWER TRANSMISSION DEVICE FOR HEV”).

### SUMMARY

Various embodiments are directed to a power transmission device for a hybrid vehicle capable of removing a clutch connecting an engine power, securing space for a first motor and a second motor, and reducing an overall length.

In an embodiment, a power transmission device for a hybrid vehicle includes: an engine configured to generate power; an input connected with the engine and configured to provide one-speed power; a first motor generator driven when power is applied; a first transmission connected with the first motor generator, positioned parallel to the input, and configured to transmit power to the input; an output engaged with the input; a second motor generator driven when power is applied; a second transmission connected with the second motor generator, positioned parallel to the output, and configured to transmit power to the output; and a differential engaged with the output and configured to provide power to wheels.

The input may include an input shaft connected with the engine, a constant input gear constantly connected with the input shaft and engaged with the first transmission, and an optional input gear optionally connected with the input shaft and engaged with the output.

The optional input gear may include a first optional gear concentrically positioned with the input shaft and engaged with the output, and an optional shift provided on the input shaft and optionally engaged with the first optional gear.

The first transmission may include a first transmission shaft connected with the first motor generator and positioned parallel to the input shaft, and a first transmission gear provided on the first transmission shaft and engaged with the constant input gear.

The output may include an output shaft positioned between the input and the second transmission, an output transmission gear provided on the output shaft and connected with the optional input gear and the second transmission, and an output differential gear provided on the output shaft and connected with the differential.

The second transmission may include a second transmission shaft connected with the second motor generator and positioned parallel to the input shaft, and a second transmission gear provided on the second transmission shaft and engaged with the output transmission gear.

The differential may include a differential gear configured to provide power to the wheels, and a differential connection provided on the differential gear and engaged with the output differential gear.

In the power transmission device for a hybrid vehicle according to the present disclosure, the input, connected to the engine, is constantly connected with the first motor generator to transmit rotational force and optionally connected with the output to transmit rotational force. The output may be constantly connected with the second motor generator to transmit rotational force and constantly connected with the differential to transmit rotational force. The input, the first transmission connected with the first motor generator, and the second transmission connected with the second motor generator are positioned parallel to each other, allowing for reduced the overall length.

### BRIEF DESCRIPTION OF THE DRAWINGS

FIG. 1 is a schematic view showing a power transmission device for a hybrid vehicle according to an embodiment of the present disclosure.

FIG. 2 is a schematic view showing a first-gear drive and a power generation mode of a first motor generator, executed by the engine in FIG. 1.

FIG. 3 is a schematic view showing a first-gear drive mode executed by the engine and the first motor generator in FIG. 1.

FIG. 4 is a schematic view showing the first-gear drive and a power generation mode of a second motor generator, executed by the engine in FIG. 1.

FIG. 5 is a schematic view showing the first-gear drive mode executed by the engine and the second motor generator in FIG. 1.

FIG. 6 is a schematic view showing the power generation mode of the first motor generator in FIG. 1.

FIG. 7 is a schematic view showing the first-gear drive mode executed by the second motor generator in FIG. 1.

FIG. 8 is a schematic view showing the first-gear drive mode executed by the engine, the first motor generator, and the second motor generator in FIG. 1.

### DETAILED DESCRIPTION OF THE ILLUSTRATED EMBODIMENTS

Hereinafter, embodiments of a power transmission device for a hybrid vehicle according to the present disclosure will be described in detail with reference to the accompanying drawings. For clarity and convenience in description, thicknesses of lines, sizes of constituent elements, and the like may be illustrated in a non-exact proportion in the drawings. In addition, the terms used below are defined in consideration of the functions thereof in the present disclosure and may vary depending on the intention of a user or an operator or common practice. Therefore, these terms should be contextually defined in light of the present specification.

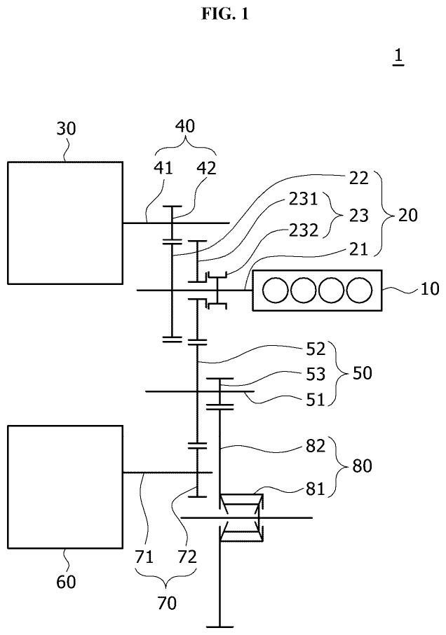

FIG. 1 is a schematic view showing a power transmission device for a hybrid vehicle according to an embodiment of the present disclosure. Referring to FIG. 1, a power transmission device 1 for a hybrid vehicle according to an embodiment of the present disclosure includes an engine 10, an input 20, a first motor generator 30, a first transmission 40, an output 50, a second motor generator 60, a second transmission 70, and a differential 80.

The engine 10 is a device that generates power by driving an internal combustion engine. The input 20 may be connected with the engine 10 and configured to provide one-speed power. For example, the input 20 may have a shaft shape and be positioned between the first transmission 40 and the second transmission 70.

The first motor generator 30 is driven when power is applied, and the first transmission 40 may be connected to the first motor generator 30. The first transmission 40 may be positioned parallel to the input 20 and transmit power to the input 20. For example, the first motor generator 30 may rotate the first transmission 40 to start the engine 10 and provide driving power. When rotational force of the input 20 is provided to the first motor generator 30 through the first transmission 40, the first motor generator 30 may generate power.

The output 50 may be engaged with the input 20. For example, the output 50 may be positioned between the input 20 and the second transmission 70. The input 20, the output 50, and the second transmission 70 may be positioned in parallel.

The second motor generator 60 is driven when power is applied, and the second transmission 70 may be connected to the second motor generator 60. The second transmission 70 may transmit power to the output 50. For example, the second motor generator 60 may rotate the second transmission 70 to provide driving power. When rotational force of the output 50 is provided to the second motor generator 60 through the second transmission 70, the second motor generator 60 may generate power.

The differential 80 may be engaged with the output 50 to provide power to wheels. For example, the differential 80 may be a differential gear that divides and distributes driving force of the right and left wheels to allow for different rotation on the right and left sides.

The input 20 according to an embodiment of the present disclosure may include an input shaft 21, a constant input gear 22, and an optional input gear 23.

The input shaft 21 may be connected with the engine 10. For example, the input shaft 21 may be directly connected to the engine 10 and rotate about the shaft when the engine 10 is driven. The input shaft 21 may be positioned between the first transmission 40 and the output 50.

The constant input gear 22 may be constantly connected to the input shaft 21. The constant input gear 22 may be engaged with the first transmission 40. For example, the constant input gear 22 may be constantly connected with the first transmission 40 to transmit power.

The optional input gear 23 may be optionally connected to the input shaft 21 and be engaged with the output 50. For example, the optional input gear 23 may be automatically or manually connected to the input shaft 21 to transmit rotational force or may be spaced apart from the input shaft 21 to limit rotational force transmission.

The optional input gear 23 may be positioned closer to the engine 10 than the constant input gear 22.

The optional input gear 23 according to an embodiment of the present disclosure may include a first optional gear 231 and an optional shift 232.

The first optional gear 231 may be concentrically positioned with the input shaft 21 and be engaged with the output 50. For example, the first optional gear 231 may be rotatably supported in a housing (not shown), and the input shaft 21 may be inserted through the first optional gear 231.

The optional shift 232 may be provided on the input shaft 21 and be optionally engaged with the first optional gear 231. For example, the optional shift 232 may be constantly connected with the input shaft 21, and connected or disconnected with the first optional gear 231 in response to an operation signal. When the optional shift 232 is connected with the first optional gear 231, rotational force of the input shaft 21 may be transmitted to the first optional gear 231. When the optional shift 232 is disconnected with the first optional gear 231, rotational force of the input shaft 21 may not be transmitted to the first optional gear 231.

The first transmission 40 according to an embodiment of the present disclosure may include a first transmission shaft 41 and a first transmission gear 42.

The first transmission shaft 41 may be connected to the first motor generator 30 and positioned parallel to the input shaft 21. For example, the first transmission shaft 41 may be connected with or configured to extend from a rotational shaft provided in the first motor generator 30.

The first transmission gear 42 may be provided on the first transmission shaft 41 and configured to remain engaged with the constant input gear 22. For example, the first transmission gear 42 and the constant input gear 22 may remain in constant connection, such that rotational force may be transmitted.

The output 50 according to an embodiment of the present disclosure may include an output shaft 51, an output transmission gear 52, and an output differential gear 53.

The output shaft 51 may be positioned between the input 20 and the second transmission 70. For example, the output shaft 51 may be rotatably supported in a housing (not shown), and the input shaft 21 and the output shaft 51 may be positioned in parallel.

The output transmission gear 52 may be provided on the output shaft 51 and connected with the optional input gear 23 and the second transmission 70. For example, the output transmission gear 52 may remain in constant connection with the optional input gear 23 and the second transmission 70.

The output differential gear 53 may be provided on the output shaft 51 and be connected with the differential 80. For example, the output transmission gear 52 may be positioned closer to the first motor generator 30 or the second motor generator 60 than the output differential gear 53.

The second transmission 70 according to an embodiment of the present disclosure may include a second transmission shaft 71 and a second transmission gear 72.

The second transmission shaft 71 may be connected to the second motor generator 60 and positioned parallel to the input shaft 21. For example, the second transmission shaft 71 may be connected with or configured to extend from a rotational shaft provided in the second motor generator 60.

The second transmission gear 72 may be provided on the second transmission shaft 71 and engaged with the output transmission gear 52. For example, the second transmission gear 72 may be constantly connected with the output transmission gear 52 to transmit power.

The differential 80 according to an embodiment of the present disclosure may include a differential gear 81 and a differential connection 82.

The differential gear 81 may provide power to the wheels. For example, the differential gear 81 may be a differential gear that distributes power to the right and left wheels.

The differential connection 82 may be provided on the differential gear 81 and engaged with the output differential gear 53. For example, the differential connection 82 may be rotatably mounted in a housing (not shown) and remain in constant connection with the output differential gear 53. The differential connection 82 may transmit rotational force of the output differential gear 53 to the differential gear 81.

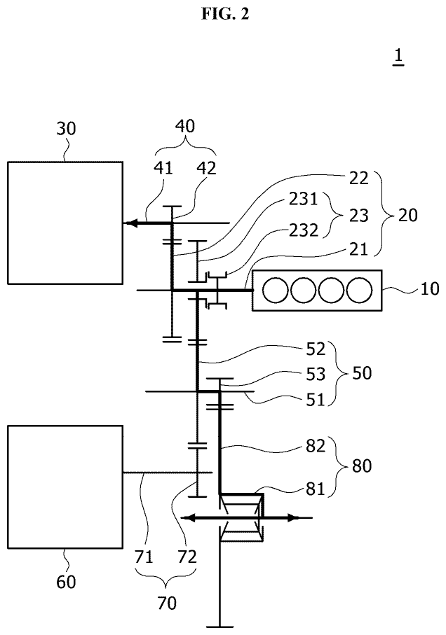

FIG. 2 is a schematic view showing a first-gear drive and a power generation mode of the first motor generator, executed by the engine in FIG. 1. Referring to FIG. 2, when the engine 10 is driven, the optional shift 232 is connected with the first optional gear 231. When the engine 10 is driven, rotational force of the input shaft 21 is transmitted to the output transmission gear 52 through the optional input gear 23 to rotate the output shaft 51. When the output shaft 51 rotates, the differential 80, connected with the output differential gear 53, rotates to provide the first-gear driving force to the wheels. When the input shaft 21 rotates, the first transmission 40 may rotate through the constant input gear 22, such that the first motor power generator 30 may generate power.

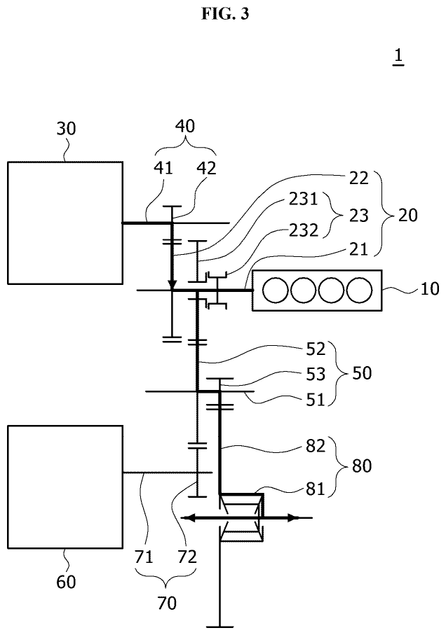

FIG. 3 is a schematic view showing a first-gear drive mode executed by the engine and the first motor generator in FIG. 1. Referring to FIG. 3, when the engine 10 and the first motor generator 30 are driven, the optional shift 232 is connected with the first optional gear 231. The driving force of the engine 10 rotates the input shaft 21. In addition, when the first transmission 40 is rotated by driving the first motor generator 30, the rotational force of the first transmission 40 is transmitted to the input shaft 21. The rotational force of the input shaft 21 is transmitted to the output transmission gear 52 through the optional input gear 23 to rotate the output shaft 51. When the output shaft 51 rotates, the differential 80, connected with the output differential gear 53, rotates to provide the first-gear driving force to the wheels.

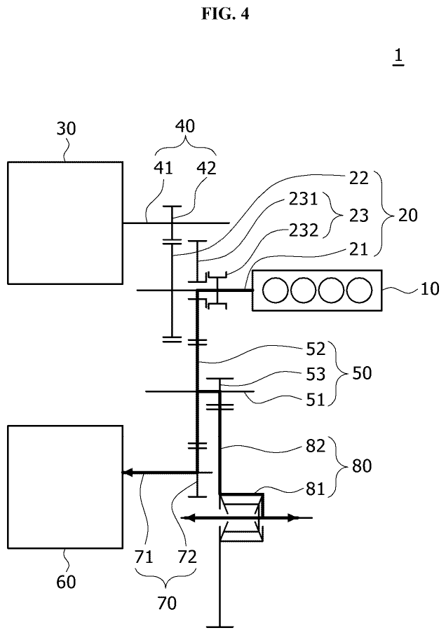

FIG. 4 is a schematic view showing the first-gear drive and a power generation mode of the second motor generator, executed by the engine in FIG. 1. Referring to FIG. 4, when the engine 10 is driven, the optional shift 232 is connected with the first optional gear 231. When the engine 10 is driven, rotational force of the input shaft 21 is transmitted to the output transmission gear 52 through the optional input gear 23 to rotate the output shaft 51. When the output shaft 51 rotates, the differential 80, connected with the output differential gear 53, rotates to provide the first-gear driving force to the wheels. When the output shaft 51 rotates, the second transmission 70 may rotate through the output transmission gear 52, such that the second motor generator 60 may generate power.

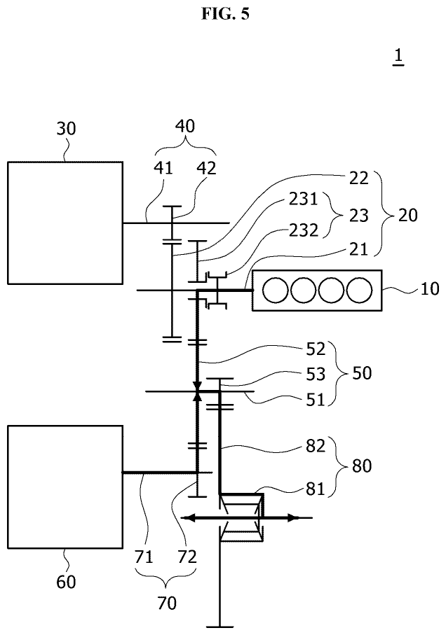

FIG. 5 is a schematic view showing the first-gear drive mode executed by the engine and the second motor generator in FIG. 1. Referring to FIG. 5, when the engine 10 and the second motor generator 60 are driven, the optional shift 232 is connected with the first optional gear 231. The driving force of the engine 10 rotates the input shaft 21. When the input shaft 21 rotates, rotational force of the optional input gear 23 is transmitted to the output shaft 51 through the output transmission gear 52. In addition, when the second transmission 70 is rotated by driving the second motor generator 60, the rotational force of the second transmission shaft 71 is transmitted to the output shaft 51 through the second transmission gear 72. The rotational force of the output shaft 51 is transmitted to the differential 80 through the output differential gear 53 to provide the first-gear driving force to the wheels.

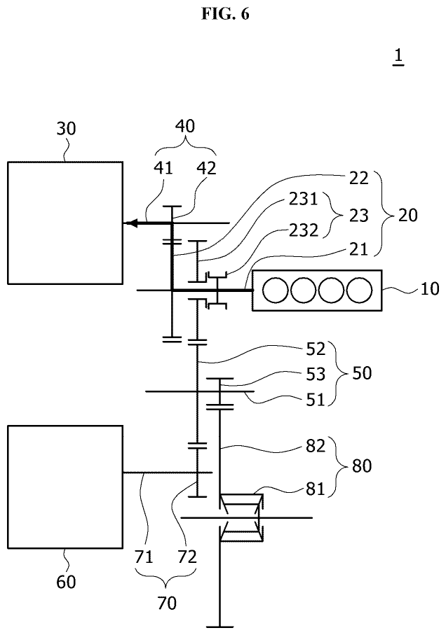

FIG. 6 is a schematic view showing the power generation mode of the first motor generator in FIG. 1. Referring to FIG. 6, when the engine 10 is driven, the optional shift 232 is disconnected with the first optional gear 231. When the engine 10 is driven, rotational force of the input shaft 21 may be transmitted to the first transmission 40 through the constant input gear 22, such that the first motor generator 30 may generate power.

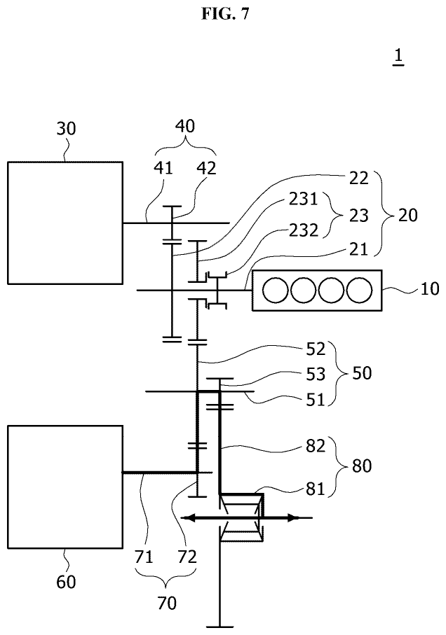

FIG. 7 is a schematic view showing the first-gear drive mode executed by the second motor generator in FIG. 1. Referring to FIG. 7, when the engine 10 is stopped and the second motor generator 60 is driven, rotational force of the second transmission shaft 71 is transmitted to the output shaft 51 through the second transmission gear 72. The rotational force of the output shaft 51 is transmitted to the differential 80 through the output differential gear 53 to provide the first-gear driving force to the wheels.

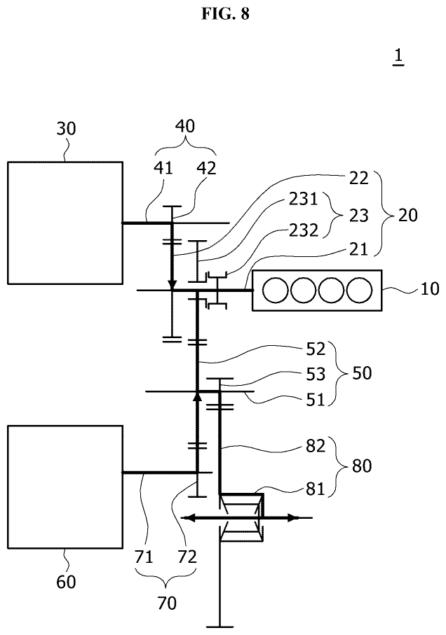

FIG. 8 is a schematic view showing the first-gear drive mode executed by the engine, the first motor generator, and the second motor generator in FIG. 1. Referring to FIG. 8, when the engine 10, the first motor generator 30, and the second motor generator 60 are driven, the optional shift 232 is connected with the first optional gear 231. The driving force of the engine 10 rotates the input shaft 21. In addition, when the first transmission 40 is rotated by driving the first motor generator 30, the rotational force of the first transmission 40 is transmitted to the input shaft 21. The rotational force of the input shaft 21 is transmitted to the output transmission gear 52 through the optional input gear 23 to rotate the output shaft 51. When the second transmission 70 is rotated by driving the second motor generator 60, the rotational force of the second transmission shaft 71 is transmitted to the output shaft 51 through the second transmission gear 72. When the output shaft 51 rotates, the differential 80, connected with the output differential gear 53, rotates to provide the first-gear driving force to the wheels.

In the power transmission device 1 for a hybrid vehicle according to an embodiment of the present disclosure, the input 20, connected to the engine 10, is constantly connected with the first motor generator 30 to transmit rotational force and optionally connected with the output 50 to transmit rotational force. The output 50 may be constantly connected with the second motor generator 60 to transmit rotational force and constantly connected with the differential 80 to transmit rotational force. The input 20, the first transmission 40 connected with the first motor generator 30, and the second transmission 70 connected with the second motor generator 60 are positioned parallel to each other, allowing for reduced an overall length.

The present disclosure has been described with reference to the embodiments illustrated in the drawings. Although the embodiments have been disclosed for illustrative purposes, those skilled in the art will appreciate that various modifications and equivalent embodiments are possible. Thus, the true technical scope of the disclosure should be defined by the following claims.

1. A power transmission device for a hybrid vehicle comprising:
an engine configured to generate power;
an input connected with the engine and configured to provide one-speed power;
a first motor generator driven when power is applied;
a first transmission connected with the first motor generator, positioned parallel to the input, and configured to transmit power to the input;
an output engaged with the input;
a second motor generator driven when power is applied;
a second transmission connected with the second motor generator, positioned parallel to the output, and configured to transmit power to the output; and
a differential engaged with the output and configured to provide power to wheels, wherein the input comprises an input shaft directly connected with the engine, and wherein the input shaft is free from any clutch.

2. The device of claim 1, wherein the input further comprises:
a constant input gear constantly connected with the input shaft and engaged with the first transmission; and
an optional input gear optionally connected with the input shaft and engaged with the output.

3. The device of claim 2, wherein the optional input gear comprises:
a first optional gear concentrically positioned with the input shaft and engaged with the output;
an optional shift provided on the input shaft and optionally engaged with the first optional gear.

4. The device of claim 2, wherein the first transmission comprises:
a first transmission shaft connected with the first motor generator and positioned parallel to the input shaft; and
a first transmission gear provided on the first transmission shaft and engaged with the constant input gear.

5. The device of claim 2, wherein the output comprises:
an output shaft positioned between the input and the second transmission;
an output transmission gear provided on the output shaft and connected with the optional input gear and the second transmission; and
an output differential gear provided on the output shaft and connected with the differential.

6. The device of claim 5, wherein the second transmission comprises:
a second transmission shaft connected with the second motor generator and positioned parallel to the input shaft; and
a second transmission gear provided on the second transmission shaft and engaged with the output transmission gear.

7. The device of claim 5, wherein the differential comprises:
a differential gear configured to provide power to the wheels; and
a differential connection provided on the differential gear and engaged with the output differential gear.
